(19) United States
(12) Patent Application Publication
(10) Pub. No.: US 2026/0107101 A1
(43) Pub. Date: Apr. 16, 2026

(54) MICROPHONE HEAD WITH CALIBRATION DATA

(71) Applicant: Sound Devices, LLC, Reedsburg, WI (US)

(72) Inventor: Matthew G. Anderson, Madison, WI (US)

(73) Assignee: Sound Devices, LLC, Reedsburg, WI (US)

(21) Appl. No.: 19/357,781

(22) Filed: Oct. 14, 2025

Related U.S. Application Data
(60) Provisional application No. 63/706,952, filed on Oct. 14, 2024.

(51) Int. Cl. H04R 29/00; H04R 1/08; H04R 1/22

(52) U.S. Cl. CPC H04R 29/004; H04R 1/083; H04R 1/222; H04R 2420/07

(57) ABSTRACT

A handheld wireless microphone body may be connected to an assortment of microphone heads, where minor variations in the frequency response of microphone heads from one to the next are accounted for using compensation filters based on unique calibration data collected as part of the manufacturing process. Multiple reference microphone heads, which may be different make and model, can be used to collect different sets of calibration data specific for each make and model. One or more unique sets of calibration data for each microphone head, or data enabling access to the calibration data, may be embedded into EEPROM on the microphone head.

### CROSS-REFERENCE TO RELATED APPLICATION

The present application claims priority to U.S. Provisional Patent Application No. 63/706,952, filed Oct. 14, 2024, the content of which is incorporated herein by reference in its entirety.

### FIELD OF THE INVENTION

The disclosed invention provides means to improve the flexibility and usability of a handheld microphone that has an interchangeable microphone head. This invention is compatible with the invention disclosed in U.S. Ser. No. 18/755,831 (the Anderson et al. '831 application), filed on Jun. 27, 2024, and entitled “Microphone Head Connector Adapter,” by Matthew Anderson and Jason McDonald, assigned to the Assignee of the present application and published as US 2025/0008250 A1, which is hereby incorporated by reference. The present invention enables a user to interchange the microphone head as disclosed in the incorporated application and applies compensation filters so that the microphone head possesses a specific set of acoustic attributes.

### BACKGROUND OF THE INVENTION

The ability for professional entertainers to provide a performance experience that meets the expectations of audiences (and themselves) is intimately linked to the performance, characteristics and nuances of the microphones they employ while on stage. Through the course of their professional careers, performers and particularly singers may become accustomed to and learn to work with the specific audio characteristics for a preferred microphone. For this reason, they often opt to use their own privately owned microphones that they have learned to work with. Unfortunately, the logistics of stage settings do not always permit the selective use of a preferred microphone on an individual basis and in many cases, it can become highly desirable that a given microphone possess a specific set of acoustic attributes that are expected by the user based on prior experience.

### SUMMARY OF THE INVENTION

The invention pertains to a handheld wireless microphone apparatus with a removable microphone head. In one disclosed embodiment, a connection adapter enables the mechanical and electrical attachment of a first type of microphone head and, if reversed, the mechanical and electrical attachment of another type of microphone head, see the incorporated Anderson et al. '831 application. A variety of microphone elements may be used in the construction of a microphone head. As a result, the perceived sound attributes will vary accordingly for different element types. Even in cases where the same type and style of microphone element is used between two different heads, subtle sound quality differences may still be perceivable due to slight variations in the manufacture of microphone elements. For example, slight variations in manufacturing may occur due to differences in the environment under which manufacturing takes place (such as ambient vibration, heat or humidity, consistency of raw materials or an attentiveness of workers) and the resultant products may still exhibit characteristics that fall within manufacturing tolerances assigned for quality control purposes. As such, when a performer uses the same microphone over an extended time, they may learn to work with the acoustic nuances of the device, leading to a sense of familiarity and comfort, being confident in how their performance will be perceived. In these cases, if a performer is required to use a different (alternative) device, they may suspect that differences in acoustic nuances will exist during their performance.

An object of this invention is to impart audio characteristics associated with a specific desired microphone head into an alternative (similar) microphone head based on a compensation filter. The design for such a compensation filter requires knowledge of the differences between the desired frequency response for a reference microphone head and the frequency response of the subject microphone head. This invention stores detailed calibration data on the subject microphone head, and a processor on the wireless microphone body applies a suitable compensation filter based on the stored calibration data. Alternatively, the compensation filter could be implemented on an RF receiver receiving the RF audio signal from the wireless microphone body. The calibration data preferably includes the raw frequency response of the subject microphone head and/or filter coefficients for the compensation filter implemented on the microphone body (or receiver) and preferably includes manufacturing identification information such as a serial number and the make and model of the reference microphone.

One key aspect of the invention is that the removable microphone head includes non-volatile memory that contains the calibration data. The calibration data as mentioned above is used to create a compensation filter that adjusts the frequency response of the removable microphone head, e.g., processing digital audio signals through the compensation filter on the microphone body adjusts the frequency response in accordance with the calibration data stored on the removable microphone head. The purpose of the compensation filter is to calibrate the frequency response, or transfer function, of the removeable microphone head so that it is the same, or at least discernably the same, as the reference microphone head used for calibration. One way to measure the transfer function imposed by the respective removeable microphone heads is to use Time-Delay-Spectrometry, as described in more detail below.

In one aspect, the invention is directed to a handheld microphone with a main body and a removable microphone head that contains its own calibration data. This calibration data, stored in non-volatile memory (like EEPROM) on the microphone head, is read by processing means in the main body of the microphone to generate a compensation filter that adjusts the frequency response of the digitally processed audio signals in accordance with the calibration data stored on the removable microphone head. While the compensation filter is preferably generated or set by the processing means on the microphone body, it is possible that the compensation filter be generated or set on other audio or computer equipment associated with the microphone, such as a receiver, and uploaded to the microphone if necessary. As mentioned above, the calibration data can take various forms like raw frequency response data, or filter coefficients. It can also take the form of microphone identification data, which would enable the raw frequency response data, or filter coefficients for the microphone head to be downloaded, e.g., from a server operated by the manufacturer.

In the preferred embodiment, the processing means on the microphone body comprises, e.g., a preamplifier, an A/D converter, an FPGA or microcontroller, an RF upconverter and an RF power amplifier. The processing means uses the compensation filter to adjust the audio signal from the microphone head, ensuring a consistent and high-quality sound. The frequency response of the removable microphone head is characterized as a transfer function that the removeable microphone head imposes when converting the detected acoustic audio to the electrical audio signal. The compensation filter in the main body adjusts the frequency response of the digitally processed audio signals from the removable microphone head to match or simulate the frequency response of a reference microphone head against which the removable microphone head is calibrated. In use, the removable microphone head detects acoustic audio input and outputs an electrical audio signal, and the processing means located within the main body receives the electrical audio signal from the removable microphone head, digitally processes the electrical audio signal using the compensation filter, and provides an audio transmission signal to an RF antenna in the microphone body for wireless RF transmission.

As mentioned, the stored calibration data on the removable microphone head is used to create a compensation filter that adjusts the frequency response of the digitally processed audio signals to match or simulate the frequency response of a reference microphone head. The invention can be used for example in connection with a factory calibration procedure to determine the calibration data, e.g. via time-delay-spectrometry (TDS) to determine calibration coefficients for the compensation filter such as coefficients for a bank of FIR filters or IIR filters.

In one embodiment, the compensation filter comprises a summed series of parallel second-order-sections (SOS) of FIR filters or IIR filters for various frequency bands or region, wherein computer optimization is used to set the gain, Q-factor and center frequency for each frequency band, and the stored calibrations coefficients comprise the optimized gain, Q-factor and center frequency for each frequency band or region.

The stored compensation data can include data for multiple compensation filters each used to adjust the frequency response of the digitally processed audio signals differently. For example, several compensation filters can be designed for a given microphone head, thereby enabling the compensated frequency response from the microphone head to match the sound of different microphone models e.g. from different manufacturers.

As mentioned previously, the handheld microphone is desirably configured as disclosed in the incorporated Anderson et al. '831 application to accommodate different microphone heads, e.g. from different manufacturers. An array of plug connectors is attached to a top end of the main body of the microphone, and a collar mechanically attaches the removable microphone head to the main body such that the array of plug connectors is arranged to receive the electrical audio signals from audio output conductors on the attached microphone head. It is desirable that the microphone body includes a rechargeable battery, and that DC power is supplied to the removeable microphone head through at least one of the plug connectors. If the microphone head is attached and it does not include calibration data or identification data relating to calibration data, a compensation filter as described is not applied.

In another aspect, the invention is directed to a removable microphone head configured to be attached to a microphone body. The microphone head includes an acoustic transducer that detects acoustic waves and generates an electrical audio signal. The removeable microphone head is configured to receive DC power from an attached microphone body and to transmit the electrical audio signal to the attached microphone body. The removeable microphone head contains non-volatile memory storing calibration data for the removable microphone head. The removeable microphone head is configured to transmit the calibration data to the attached microphone body which implements compensation filtering during digital processing of the electrical audio signal output from the removable microphone head. Alternatively, the compensation filtering can occur in an RF receiver that receives the audio signal from the RF antenna on the microphone body.

Other embodiments and features of the invention may be apparent to those skilled in the art upon review of the drawings and the following description thereof.

### BRIEF DESCRIPTION OF THE DRAWINGS

FIG. 1 is a view illustrating the attachment of a removable microphone head to a microphone body using a reversable microphone head adapter as disclosed in the incorporated Anderson et al. '831 application, and in accordance with an exemplary embodiment for the present invention.

FIG. 1A is a diagram illustrating electrical components of a wireless microphone implementing an exemplary embodiment of the invention.

FIGS. 2A and 2B are block diagrams showing methods to generate microphone head calibration data. The block diagram of FIG. 2A illustrates a method for generating calibration data that utilizes analog signal processing, while that of FIG. 2B illustrates a method that is based on digital signal processing.

FIG. 3 shows a block diagram representing the construction of a parametric equalizing filter that may be applied as a compensation filter in dependence on calibration parameters.

FIG. 4 is a diagram indicating stages of production and use of a microphone head where microphone calibration data may be measured or used.

### DETAILED DESCRIPTION OF THE INVENTION

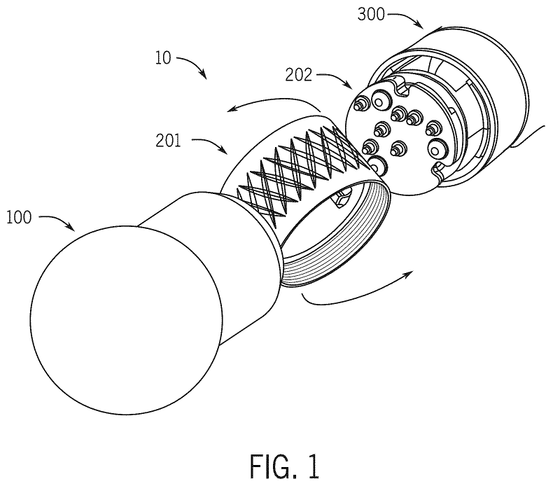

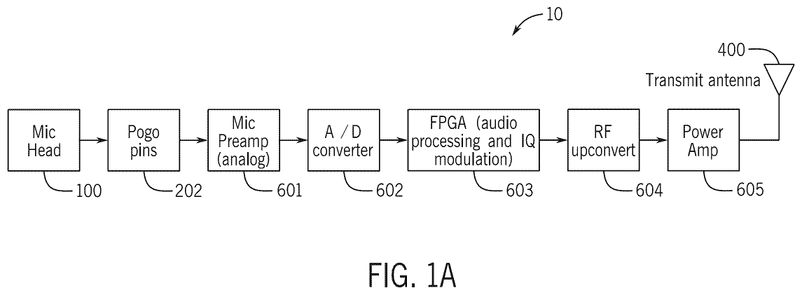

The present invention is directed to the acoustic calibration of removeable microphone heads, like the removeable microphone head 100 shown in FIG. 1. Referring to FIG. 1, the removeable microphone head 100 in the exemplary embodiment is the same or similar to the configuration described in the incorporated Anderson et al. '831 application. A removable microphone head adapter collar 201 is reversible and is affixed to a microphone body 300. FIG. 1 shows an adapter collar 201 that is mechanically fixed to the top of the microphone body 300 using a keyed locking mechanism. Alternatively, the collar adapter 201 can be attached to the top of the microphone body 300 with screws or other suitable mechanical connectors. The orientation of the collar adapter 201 is selected to accommodate the thread size of the selected microphone head 100, which is removably attached to the microphone body 300 by screwing the microphone head 100 into the adapter collar 201 when the adapter collar 201 is attached to the microphone body 300. It is not necessary that the adapter collar 201 be reversible in order to implement the present invention. The pins 202 on the top of the microphone body 300 are preferably spring-loaded to ensure robust electrical contact with the microphone head 100, when the microphone head 100 is fully screwed on to the microphone body 300. The pins 202 are used to transmit electrical signals from microphone head 100 to the microphone body 300 and to provide DC power from the microphone body 300 to the microphone head 100, generally as described in the incorporated Anderson et al. '831 application. The reference number 10 refers to the wireless microphone 10 generally.

FIG. 1A illustrates the flow of audio data as it is processed through the wireless microphone 10 and the transmitted from an RF antenna 400. The microphone head 100 generates an analog audio signal which is transmitted from the head 100 to the assigned connection pins 202 on the microphone body 300. From the pins 202, the analog audio signals are amplified through an analog preamplifier 601 and then digitized by an analog-to-digital converter 602. The digitized audio signals are processed in a microcontroller which in FIG. 1A is a field programable gate array (FPGA) 603. The FPGA 603 implements audio processing, including compensation filtering in accordance with the invention, and IQ modulation. The processed digital output from the FPGA 603 is RF upconverted 604 and amplified 605. The amplified analog signal is then transmitted to antenna 400 for radio transmission to a receiver. The processing means comprises the following physical components: the preamplifier 601, the A/D converter 602, the FPGA or microcontroller 603, the RF upconverter 604 and an RF power amplifier 605. Although not shown in FIG. 1A, the microphone body 300 also includes a battery and power conversion and charging electronics, as is typical in art. DC power is supplied from the microphone body 300 to the attached microphone head 100 via one of the pins 202.

In a production environment, a support team may maintain a collection of microphone head types depending on the preferences for individual members of a talent team. In some cases, multiple team members may prefer a microphone head 100 having the same make and model as one or more of their cohorts. Unless individual tracking for each microphone head 100 is maintained, the possibility remains that a given member of the talent team may end up using over time different microphone heads 100 of the same make and model, even if they have a preference for a given make and model. The manufacturing of microphone heads is not an exact science. Despite best efforts at quality control, there remains the possibility that two microphone heads 100, even having the same manufacturer and model type, may exhibit perceptible differences in acoustic nuances while in use.

To address these issues, this invention embodies embedding distinct calibration data into each individual microphone head. As discussed above, the calibration data preferably includes the raw frequency response of the subject microphone head and/or filter coefficients for the compensation filter implemented on the microphone body (or receiver) and preferably also includes manufacturing identification information such as a serial number and the make and model of the reference microphone. The method relies on taking measurements for the transfer function (or frequency response) that the microphone head imposes on the transfer of detected audio energy from an input physical audio acoustic wave to its electrical output. Several convenient means to measure frequency response known as Time-Delay-Spectrometry (TDS) are well-known methods from the prior art and can be used to implement the invention. These TDS techniques may be performed in either the analog or digital domains.

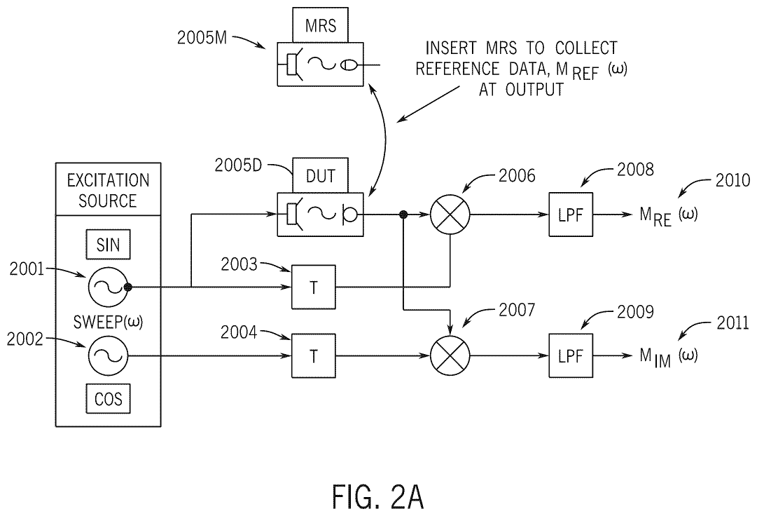

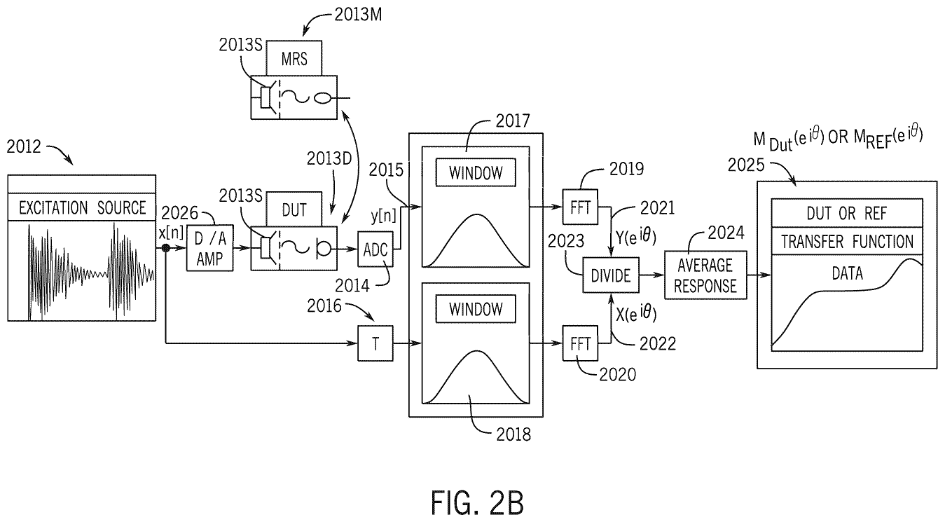

Both analog and digital methods of transfer function measurement are suitable. FIG. 2A illustrates an analog technique to perform TDS measurement, while FIG. 2B illustrates a corresponding digital technique. Both methods work by providing an excitation signal to the input of a device under test (DUT) (see, 2005D in FIG. 2A or 2013D in FIG. 2B) and comparing this with the output. The DUT may be constructed using a loudspeaker (2005S in FIG. 2A, 2013S in FIG. 2B) that is acoustically coupled with a test microphone situated in a (preferably) quiet environment. At a preliminary stage for product development, a “measurement reference system” (MRS) (labelled “2005M” in FIG. 2A or “2013M in FIG. 2B) may include a microphone head that has been carefully selected as a desired (master) unit that subsequent units are to be compared to, having a transfer function that customers would presumably prefer replicated for all subsequently produced heads. It is noted that the same loudspeaker (2005S in FIG. 2A, 2013S in FIG. 2B) is preferably used when testing the DUT and the reference microphone head in the MRS. An acoustic excitation source (2001 and 2002 in FIG. 2A, or 2012 in FIG. 2B) is used to drive the loudspeaker (2005S in FIG. 2A, 2013S in FIG. 2B) in the DUT (2005D in FIG. 2A or 2013D in FIG. 2B) to produce an acoustic signal that is detected by the microphone head in the DUT.

Referring to FIG. 2A, the acoustic excitation source 2001 and 2002 takes the form of a swept sine wave ranging over a frequency range of interest. This source may produce a set of output sine-waveforms 90 degrees out of phase whose frequency linearly ramps over a desired range of interest (ROI). For example, the ROI may extend from 20 Hz to 20 kHz to cover the range for human hearing (for people with normal hearing) and the time for the sweep may be 1 to 3 seconds. Still referring to the analog system of FIG. 2A, the output from the DUT 2005D is correlated with a delayed version of the output 2001 and 2002 of the excitation source at multipliers 2006 and 2007, respectively. Both the in-phase and quadrature outputs from the excitation source 2001 and 2002 pass through delay lines 2003 and 2004, respectively. The delay time, T, is set to approximate the acoustic (air) delay between the loudspeaker 2005S and microphone head in the DUT 2005D to synchronize the demodulation at multipliers 2006, 2007. For example, if d=50 cm of airspace exists between the loudspeaker and microphone head in the DUT 2005D, the amount of delay may be approximated as:

$$T = \frac{d}{c} = \frac{0.5 m}{343 / s} - 1.5 ms$$

In cases where a swept sine is applied as an excitation source, it is desired to keep the frequency of the output from the DUT 2005D and time delays 2003 and 2004 as closely correlated as possible. This reduces the risk of modulation artifacts interfering with proper measurement for in-phase and quadrature components at the outputs of low-pass-filters (LPF's) 2008 and 2009.

Another way to interpret the operation of FIG. 2A is that the multipliers 2006 and 2007 demodulate the frequency response of the DUT 2005D to an in-phase (real), Mᵣₑ(jω) 2010 and quadrature (imaginary) component, Mᵢₘ(jω) 2011 that is extracted by the low-pass-filters 2008 and 2009, respectively, where at frequency ω

$${M}_{D U T} ( j ω ) = {M}_{r e} ( j ω ) + j {M}_{i m} ( j ω )$$

The dB gain for the DUT 2005D at frequency ω is

$${M}_{DUT , dB} ( j ω ) = 10 {log}_{10} ( {M}_{DUT}^{2} ( j ω ) ) dB = 10 ( {log}_{10} ( {M}_{r e}^{2} ( j ω ) + {M}_{i m}^{2} ( j ω ) ) dB$$

For some embodiments, it may be sufficient to store calibration data in the form of resultant dB gains for a predetermined set of frequencies that are logarithmically spaced over the ROI.

Measurements for M_{Ref}dB(ω) are previously obtained from the analog system by substituting the measurement reference system 2005M for the DUT 2005D as shown in FIG. 2A. In this way, the frequency response for the preferred microphone head, i.e. the microphone head in MRS 2005M in FIG. 2A, is determined as a baseline frequency response. The compensation filter is based on the differences between the measured frequency response of the DUT 2013D and the baseline frequency response of the MRS 2013M, assuming for purposes of illustration that the response of the loudspeaker 2005S is consistent with respect to its use in the DUT 2005D and the MRS 2005M. If the response of the loudspeaker 2005S changes over time or with respect to its use in the DUT 2005D or MRS 2005M, these changes may need to be factored in to obtain more accurate calibration.

The operation of the digital system of FIG. 2B is similar in many ways to the analog system of FIG. 2A, except that with digital data, it is more convenient (and efficient) to perform many of the required operations in the frequency domain. Another advantage of the digital method is that the excitation source 2012 may be configured to emit a filtered random noise source rather than a swept sinewave, where the frequency response for the DUT 2013D may be measured for multiple points in frequency simultaneously. The excitation source 2012 is applied to drive the loudspeaker 2013S in the DUT 2013D over the testing period, e.g., 48 kHz sampling rate, sweeping 10 Hz to 20 kHz over about 2 seconds. The digital output x[n] from the excitation source 2012 is fed to a digital-to-analog converter and an amplifier, see 2026, to generate an analog signal to drive the loudspeaker 2013S in the DUT 2013D. The digital output x[n] from the excitation source 2012 is also fed to a digital time delay 2016. The electrical output from the microphone head of the DUT 2013D is amplified and applied as the input to an analog-to-digital converter (ADC) 2014 to produce a digital output signal y[n], see 2015. The digital output signal y[n] is a time series and is fed as the input to a window function 2017 and the time series output from the digital time delay 2016 is supplied as input to another window function 2018. For example, if a sampling rate of Fₛ=48 kHz used by the ADC 2014 and d=50 cm of airspace exists between the loudspeaker 2013S and microphone of the DUT 2013D, the amount of digital delay 2016 may be approximated as:

$$T = \frac{{dF}_{s}}{c} = \frac{( 0.5 m ) ( 48000 \frac{samples}{s} )}{343 / s} = 70 samples$$

Upon application of the window functions 2017, 2018 to align the respective inputs, the results are applied to Fast Fourier Transfer (FFT) functions 2019 and 2020 to produce frequency domain representations for the DUT output, Y(e^{jθ}) 2021 and the delayed version for the digital sequence, x[n], represented in the (windowed) frequency domain by X(e^{jθ}) 2022, where θ represents a discrete-time frequency such that θ=0 corresponds to zero frequency and θ=π corresponds to the half sample rate, F_{S}/2. By taking the ratio for these two frequency-domain measurements, see box 2023, over the time of testing, the average frequency response is obtained, see box 2024. Box 2025 shows the transfer function data in the frequency domain (i.e. frequency response) displayed, where M_{DUT}(e^{jθ}) represents the frequency response for the DUT 2013D and M_{REF}(e^{jθ}) represents the frequency response for the measurement reference system (MRS 2013M) in the case where the MRS 2013M is inserted into the position of the DUT 2013D. The frequency response M_{DUT}(e^{jθ}) is generally:

$${M}_{D U T} ( {e}^{j θ} ) = \frac{Y ( {e}^{j θ} )}{X ( {e}^{j θ} )}$$

The digital delay 2016 affects only X(e^{jθ}) in the denominator term, and accounts for the phase delay due to the airgap between the loudspeaker 2013S and microphone in the DUT 2013D (or reference microphone in MRS, 2013M).

Once measurements have been completed for both the MRS 2013M and DUT 2013D, transfer functions (where M_{DUT}(e^{jθ}) and M_{REF}(e^{jθ})) may be stored as calibration data in the microphone head 100 of the DUT. Assuming that all components are kept within their linear range of operation, a linear relationship should exist between measurements taken for an MRS (2005M or 2013M) as compared to each DUT (2005D or 2013D).

The M_{DUT} transfer function is particularly useful when combined with a corresponding set of M_{REF} transfer function data that was measured for a reference microphone head known to possess a set of known, and preferred characteristics, that may not always be exactly replicated from one manufactured microphone head to the next. This invention envisions that once the calibration data for a given microphone head is available, a compensation filter is designed such that the compensated electrical audio output matches the electrical audio output of the reference microphone head. By taking the ratio of these measurements, a transfer function defining a compensation filter is formulated that when inserted into the output path of a microphone with the DUT microphone head (2005D or 2013D), results in a microphone head that mimics the MRS (2005M or 2013M). In particular, the discrete-time correction transfer function (referred to here as the “compensation filter equation”)

$$H ( {e}^{j θ} ) = \frac{{M}_{R e f} ( {e}^{j θ} )}{{M}_{D U T} ( {e}^{j θ} )}$$

With the analog approach, the compensation filter equation has an analogous form:

$$H ( ω ) = \frac{{M}_{R e f} ( ω )}{{M}_{D U T} ( ω )}$$

The compensation filter may be applied to the output of a microphone evaluated as a DUT (FIG. 2A, 2005D or FIG. 2B 2013D), to correct for subtle differences in gain over frequency that may occur from one microphone head (of a similar type/model) to the next. It is worth noting that the phase terms due to the digital delays (FIG. 2A 2003, 2004 or FIG. 2B 2016) will exist in both terms (numerator and denominator within either compensation filter equation), so these will simply cancel each other. By applying a filter to the output of a DUT whose transfer function closely follows the compensation filter equation, performers may use that DUT microphone to experience (and enjoy) a closely replicated set of (preferred) acoustic nuances matching those of a reference microphone they have grown accustomed to, even after changing from one microphone head (of the same type/model) for another.

Once calibration data is available for a specific microphone head, several methods may be taken from the prior art for formulating a compensation filter that when applied to it, will render its response closer to a desired specification. We may assume that the discrete-time transfer function has been calculated (as described above) for a set of frequencies over a frequency range of interest (ROI) (for example 20 Hz to 20 kHz), where this set is denoted by

$$\overline{f} = \{ {f}_{1} , {f}_{2} , {f}_{3} , {f}_{4} , … {f}_{N} \}$$

with its corresponding data values

$$\overline{H} , = \{ H ( {e}^{j {θ}_{1}} ) , H ( {e}^{j {θ}_{2}} ) , H ( {e}^{j {θ}_{3}} ) , H ( {e}^{j {θ}_{4}} ) , … H ( {e}^{j {θ}_{N}} ) \}$$

where θₖ₌2πfₖ/Fₛ for k=1, 2 . . . . N. For some embodiments, these frequency points may be logarithmically spaced over the ROI. Another expanded set of transform domain points, Ĥ, may be formed by interpolating between each member of H̅. A set of FIR time-domain coefficients may be derived by taking the inverse transform (IFFT) for either the original or expanded set that will, in general, produce a noncausal filter impulse response. This may be remedied by either sliding these coefficients to the right in the time-domain or by applying a linearly increasing phase term to each member of H̅, (or Ĥ) such that the inverse transform becomes causal. Unfortunately, the added latency introduced by these operations may be considered intolerable for many applications. As an alternative, an IIR filter may also be produced that includes (or closely approximates) the desired transform domain points.

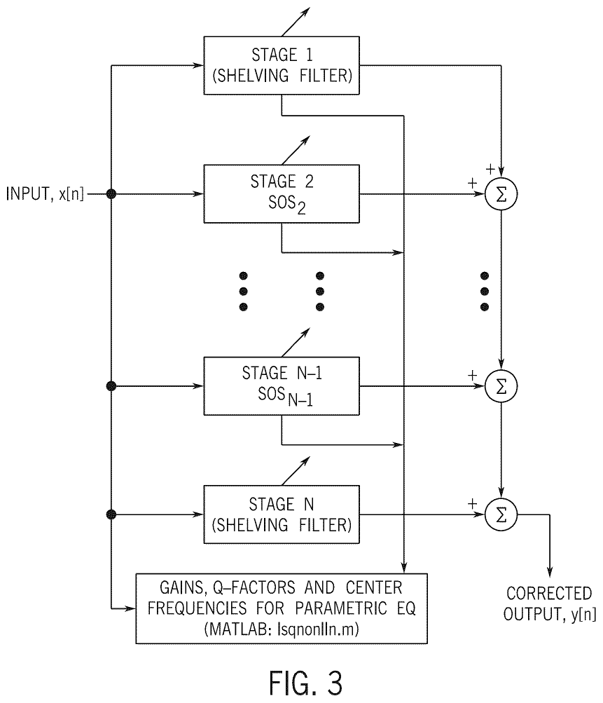

In the art, a common way to compensate for frequency dependent amplitude variations through an acoustic plant has been accomplished through the use of parametric equalizers (EQ's). An IIR filter-based realization for a parametric EQ may be constructed by adding the output from a series of parallel second-order-sections (SOS) as shown in FIG. 3. It is worthy to note that the end filters (lowest and highest frequency stages denoted by indexes 1 and N) may be configured as shelving filters, while the remaining stages (indexed 2 through N−1) may be set to form a series of band-pass-filters (BPFs) having a desired the gain, center frequency and Q-factor for each of the SOS stages. Experimental data has shown that using a corrections filter containing a setting of N=12 stages will produce satisfactory results. Using a much larger number of stages with as many as N=100 stages has also shown promising results regarding the performance of a compensation filter.

A goal of the invention is to select a gain, gₖ Q-factor, Qₖ and center frequency, fₖ for each BPF (denoted collectively by a (gₖ, fₖ, Qₖ) triplet for the k^{th} stage) such that, with properly designed shelving filters, the resultant transfer function for the filter structure of FIG. 3 approximates the gain for points in H̅, (or Ĥ) as close as possible while at the same time provides sensible interpolation between them. Minimizing the sum of squares for gain differences between the resultant filter and points in H̅ results in a nonlinear problem that may be formulated as a function of the (gₖ, fₖ, Qₖ) triplet parameters that collectively constitute a parameter space, x. An effective method for solving this mathematical problem is known in the art and has been incorporated into a commercial mathematical software routine known as “Isqnonlin” as a feature of the Optimization Toolbox package (version 24.1) as sold by The Math Works, Inc. “Isqnonlin” optimizes the following sum-of-squares over the parameter space, x:

$${min}_{x} {‖ f ( x ) ‖}_{2}^{2} = {min}_{x} ‖ {{f}_{1} ( x )}^{2} + {{f}_{2} ( x )}^{2} + … {{f}_{n} ( x )}^{2} ‖$$

This equation is subsequently referred to as the “optimization equation”. This equation may be set up to solve for the parametric filter parameters by defining the right side to formulate the difference between the magnitude (squared) of the response for the parametric EQ filter and the desired compensation filter. A set of constraints may be added (with respect to allowed values for x) when solving to prevent ill-conditioned solutions from being attempted. According to documentation from The Mathworks, Inc. (version 24.1), the optimization equation is solved using a gradient descent strategy, where a trajectory is navigated through the (gₖ, fₖ, Qₖ) triplet parameter space x until a minimum for the optimization equation is achieved. At this point, having minimized the difference between the parametric EQ and desired compensation filter, the optimal (gₖ, fₖ, Qₖ) triplets (or resultant filter coefficients) may be saved to NVRAM (non-volatile random-access memory) or EEPROM (electrically erasable programmable read-only memory) for later use by the microphone 300 or RF receiver applying the compensation filter.

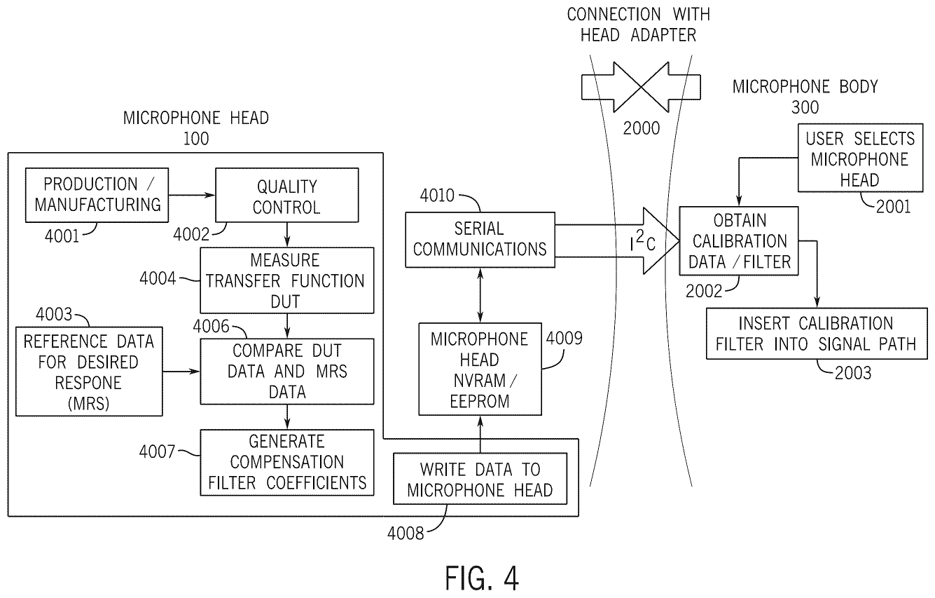

The application and utility of this invention may be more easily appreciated upon considering FIG. 4, which references steps of in the manufacturing, calibration and use of the microphone head 100. The first step in life cycle of the microphone head 100 is its manufacture at step 4001. A quality control inspection and test occur at step 4002 to verify basic proper function and reliability for the microphone head 100. A diligent manufacturer always maintains best efforts to minimize defect rates and maintain consistency between units for a given model, but manufacturing tolerances exist. Despite best efforts in quality control at step 4002, there inevitably exists the possibility of subtle differences when comparing two manufactured microphone heads 100 side by side. In particular, the transfer function (or frequency response) defined by the relationship between the input acoustic waveform to electrical output from these devices (even when comparing multiple units having the same model assignment) may entail variations in gain at specific frequencies by as much as a fraction of a decibel to slightly more than a decibel. Step 4004 represents measuring the calibration transfer function (for a newly manufactured microphone head 100) by applying an acoustic test stimulus to the microphone head (being used as a DUT) and measuring the frequency response. Reference data representing the measured transfer function of a preferred (reference) microphone head (MRS) is retrieved at step 4003. The reference data for step 4003 was previously collected using laboratory data for a model reference microphone (MRS) and is stored to be used for all microphone heads 100 that have the same model number or type that are subsequently manufactured. Then at step 4006, a comparison is made between measured microphone head data (DUT) and that for the reference microphone (MRS). At this step, adjustments can be in case the preferred reference microphone head for the MRS has changed or the loudspeaker 2013S in the MRS has changed since the reference data retrieved in step 4003 was collected. The reference data 4003 and the DUT data 4005 are used to formulate the coefficients for the compensation filter, see step 4007, that when applied to the output of the microphone head 100 will correct its frequency response and cause it to mimic the (preferred) transfer function for the reference microphone. In step 4008, the calibration data is written onto non-volatile memory (NVRAM) or EEPROM that has been embedded into the electronics for the microphone head 100. Step 4009 represents the permanent storage of the calibration data on non-volatile memory on the microphone head 100.

An important aspect of the steps leading up to step 4009 in the preferred embodiment of implementing the invention is that steps 4001-4008 are completed as part of a factory calibration procedure that results in calibration data that is unique to each microphone head 100. The form of the stored calibration data in the preferred embodiment includes the coefficients for the compensation filter that is implemented on the processor (FPGA) on the microphone body 300. However, the stored calibration data can alternatively or in addition include identification information that enables the processor on the microphone body, or other audio equipment or computers communicating with the microphone body, access to the unique coefficients for the compensation filter and/or the raw DUT calibration data and/or the reference data.

Referring now to the right side of FIG. 4, a given microphone head 100 is selected for use (at step 2001), and according to the teachings of the incorporated Anderson et al. '831 application, the microphone head 100 is connected (step 2000) using the adapter collar 201, FIG. 1. As further taught in the incorporated Anderson et al. 831 application, upon its connection, pins 4 and 5 (annular pins in the connection adapter 202) provide I²C or UART serial communications between the microphone head 100 and microphone body 300. Step 4010 in FIG. 4 indicates that the factory programmed, calibration data stored on the microphone head 100, see step 4009, is transmitted to the microphone body 300 via serial communication. Then in the microphone body 300 at step 2002, the processor in the microphone body 300 obtains the calibration data specific to the attached microphone head 100, which in the case of the preferred embodiment are the coefficients for the compensation filter. Subsequently, at step 2003, the processor (FPGA 603 9n FIG. 1A) inserts the desired compensation filter into the signal path for the output of the microphone head 100 to correct for any anomalies that were derived during the calibration phase steps 4003 to 4006. In the preferred embodiment of the invention, the filter coefficients are derived as part of the factory calibration at steps 44003-4006 and written to non-volatile memory 4009 on the microphone head 100, and directly transmitted to the microphone body 300 after it is connected to a microphone head 100.

For some embodiments, it may be preferrable that calibration data is in the form of dB offsets at step 2002, or other raw DUT calibration data or partially processed calibration data. From these, the processor in the microphone head 100 can derive coefficients for the desired correction filter or can communicate wirelessly to another component that calculates the filter coefficients, as described earlier in this disclosure, for use by the microphone processor 603.

In the embodiment shown in FIG. 4, the compensation filter is obtained as part of the operation of the microphone 10 although the compensation filter can be obtained and implemented in the RF receiver if so desired.

The inventors have envisioned alternative configurations considered to be within the scope of this invention. For example, other embodiments envisioned by this disclosure may include those where compensation filters are formulated in-situ where the microphone output collected during performances is compared with prior recordings for the purpose of quantifying a transfer function relating to the performance of the microphone head in use to that from a preferred microphone previously used. Further embodiments envisioned by this disclosure include those where rather than an IIR compensation filter, an FIR filter is used where filter design is based on a frequency sampling method. The scope of this invention also anticipates embodiments where the compensation filter is based on an arrangement of second order sections placed in series, possibly in combination with other parallel sections and/or stages.

The invention can be implemented to include stored calibration data (e.g. compensation filter coefficients) for more than only a single reference microphone. For example, if a performer happens to use a microphone they find to be highly desirable, reference data from this microphone can be measured and implanted on the performer's microphone head to replace or supplement the factory reference microphone data previously stored on the performer's microphone head.

While this disclosure focuses on placing data storage components (EEPROM) internal to the microphone head as a preferred mode, other storage modalities have been envisioned by the inventors whereby for example, EEPROM may also be placed in a microphone body. Upon attachment of a microphone head to a microphone body, the microphone head may communicate a serial number to the microphone body, allowing it to reference a manufacturing calibration database containing information about that head. Rather than relying on internal EEPROM components, a microphone head (or microphone body) may also be constructed to interface a micro-USB memory card (or other suitable portable memory storage) that may be programmed with calibration data before it is shipped with the microphone head by a manufacturer. Alternatively, this data may also be made available for internet download by the manufacturers of a microphone head for users after they have purchased a compatible microphone head based on an identifying serial number for the microphone head.

A microphone head manufacturer may choose to provide similar benefits to those described above for microphone heads that were manufactured prior to this invention. For example, a manufacturer could offer a service whereby a user ships an older microphone head to them for calibration measurement to later be returned. After these heads are returned to the users, calibration data can be accessed from the internet based on an identifying serial number assigned to the microphone head. This data could then be ported into a compatible microphone or designated audio equipment downstream from the microphone output that is capable of providing a compensation filter. For some applications, a device may be constructed that is dedicated to implementing a compensation filter and placed in line with the output of the microphone when using older audio equipment in order to provide benefits similar to those described in connection with the preferred embodiment of the invention.

1. A handheld wireless microphone apparatus:
a main body;
a removable microphone head that detects acoustic audio input and outputs an electrical audio signal;
an RF antenna located in a the main body;
processing means located within the main body that receives the electrical audio signal from the removable microphone head, digitally processes the electrical audio signal, and provides an audio transmission signal to the RF antenna for wireless RF transmission;
non-volatile memory in said removable microphone head comprising stored calibration data for the removable microphone head;
wherein said processing means comprises a compensation filter that adjusts the frequency response of the digitally processed audio signals in accordance with the calibration data stored on the removable microphone head.

2. The handheld microphone apparatus according to claim 1 wherein the stored calibration data adjusts the frequency response of the digitally processed audio signals to match or simulate the frequency response of a reference microphone head.

3. The handheld microphone apparatus according to claim 2 wherein a factory calibration procedure is used to determine the calibration data.

4. The handheld microphone apparatus according to claim 3 wherein the factory calibration procedure uses time-delay-spectrometry (TDS), in part, to determine calibration coefficients for the compensation filter.

5. The handheld microphone apparatus according to claim 4 wherein the compensation filter comprises a bank of FIR filters or IIR filters.

6. The handheld microphone apparatus according to claim 5 wherein the compensation filter comprises a summed series of parallel second-order-sections (SOS) of FIR filters or IIR filters for various frequency bands, wherein computer optimization is used to set the gain, Q-factor and center frequency for each frequency band, and the stored calibrations coefficients comprise the optimized gain, Q-factor and center frequency for each frequency band.

7. The handheld microphone apparatus according to claim 1 wherein the non-volatile memory in said removable microphone head is EEPROM.

8. The handheld microphone apparatus according to claim 1 wherein the stored calibration data includes data for multiple compensation filters each used to adjust the frequency response of the digitally processed audio signals differently.

9. The handheld microphone apparatus according to claim 1 further comprising:
an array of plug connectors attached to a top end of the main body, said array of plug connectors being arranged to receive the electrical audio signals from audio output conductors on the removable microphone head;
a collar that mechanically attaches the removable microphone head to the main body.

10. The handheld microphone apparatus according to claim 9 wherein the microphone body includes a rechargeable battery, and the DC power is supplied to the removeable microphone head through at least one of the plug connectors.

11. The handheld microphone apparatus according to claim 1 wherein the frequency response of the removable microphone head is characterized as a transfer function that the removeable microphone head imposes when converting the detected acoustic audio to the electrical audio signal, and the compensation filter adjusts the frequency response of the digitally processed audio signals from the removable microphone head to match or simulate the frequency response of a reference microphone head against which the removable microphone head is calibrated.

12. The handheld microphone apparatus according to claim 1 wherein the processing means comprises a preamplifier, an A/D converter, an FPGA or microcontroller, an RF upconverter and an RF power amplifier.

13. A removable microphone head configured to be attached to a microphone body that provides DC power to the removable microphone head and receives an electrical audio signal from the removeable microphone head, digitally processes the electrical audio signal, and provides an audio transmission signal to an RF antenna for wireless RF transmission, wherein the removable microphone head comprises:
an acoustic transducer that detects acoustic waves and generates the electrical audio signal; and
non-volatile memory storing calibration data for the removable microphone head, said calibration data being transmitted to the microphone body and used to implement compensation filtering that adjusts the frequency response of the digitally processed audio signals to match or simulate the frequency response of a reference microphone head against which the removable microphone head is calibrated.

14. The removable microphone head as recited in claim 13 wherein the stored calibration data comprises coefficients for the compensation filtering.

15. The removable microphone head as recited in claim 13 wherein the non-volatile memory in said removable microphone head is EEPROM.

16. The removable microphone head as recited in claim 13 wherein compensation filtering is implemented on the microphone body during the digital processing of the electrical audio signal that is output from the removable microphone head and received by the microphone body.

17. The removable microphone head as recited in claim 13 wherein the stored calibration data includes ID information suitable for retrieving calibration data from a database which stores calibration data for multiple removable microphone heads, said calibration data being optimized to adjust the frequency response of the digitally processed audio signals to match or simulate the frequency response of a reference microphone head against which the removable microphone head is calibrated.

18. The removable microphone head as recited in claim 13 wherein the compensation filter comprises a summed series of parallel second-order-sections (SOS) of FIR filters or IIR filters for various frequency bands, wherein computer optimization is used to set the gain, Q-factor and center frequency for each frequency band, and the stored calibrations coefficients comprise the optimized gain, Q-factor and center frequency for each frequency band.

19. The removable microphone head as recited in claim 13 wherein compensation filtering is implemented on an RF receiver that receives wirelessly transmitted audio signals from an antenna on the microphone body.
